(19) United States
(12) Patent Application Publication
(10) Pub. No.: US 2023/0099256 A1
(43) Pub. Date: Mar. 30, 2023

(54) STORING AN INDICATION OF A SPECIFIC DATA PATTERN IN SPARE DIRECTORY ENTRIES

(71) Applicant: Advanced Micro Devices, Inc., Santa Clara, CA (US)

(72) Inventor: Paul J. Moyer, Fort Collins, CO (US)

(73) Assignee: Advanced Micro Devices, Inc., Santa Clara, CA (US)

(21) Appl. No.: 17/489,712

(22) Filed: Sep. 29, 2021

(51) Int. Cl. G06F 12/0817

(52) U.S. Cl. CPC G06F 12/0828; G06F 2212/621

(57) ABSTRACT

A system and method for omission of probes when requesting data stored in memory where the omission includes creating a coherence directory entry, determining whether cache line data for the coherence directory entry is a trackable pattern, and setting an indication indicating that one or more reads for the cache line data can be serviced without sending probes. A system and method for providing extra data storage capacity in a coherence directory where the extra data storage capacity includes actively tracking cache lines, invalidating the cache line and informing the coherence directory, determining whether data is a trackable pattern, updating the coherence directory that the cache line is no longer in cache, updating the coherence directory to indicate cache line data is zero, and servicing reads to the cache line from the coherence directory and supplying the specified data.

### BACKGROUND

Modern microprocessors implement a wide array of features for high throughput. Some such features include having highly parallel architectures and storing an indication of a specific data pattern in spare directory entries. Improvements to such features are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more disclosed implementations can be implemented;

FIG. 2 is a block diagram of an instruction execution pipeline, located within the processor of FIG. 1;

FIG. 3 is a block diagram of a computer system, according to an example;

FIG. 4 is a block diagram of a computer system capable of executing a store and read using an indication of a specific data pattern, according to another example;

FIG. 5 is a flow diagram of a method 500 for storing an indication of a specific data pattern in a spare directory, according to an example;

FIG. 6 is a flow diagram of a method 600 for storing an indication of a specific data pattern in a spare directory, according to an example;

FIG. 7 illustrates a method for omission of probes, according to an example; and

FIG. 8 illustrates a method for extra data storage capacity, according to an example.

### DETAILED DESCRIPTION

In computing, a cache is a hardware or software component that stores data allowing for future requests for that data to be served faster as compared to other memory locations communicatively located further from the processor. By way of example, the data stored in a cache might be the result of an earlier computation or a copy of data stored elsewhere. A cache hit occurs, responsive to a probe or request, when the requested data can be found in a cache, while a cache miss occurs when the requested data cannot be found in the cache. Cache hits are served by reading data from the cache, which is faster than recomputing a result or reading from a slower data store. As is understood, the more requests that can be served from the cache, the faster the system performs.

In order to gain the benefit of the use of the cache and the data stored therein, it is important to maintain an understanding of the accuracy of the data in the cache. While there are numerous utilized protocols for maintaining the data in the cache, one such protocol is the MESI protocol, which is a common invalidate-based cache coherence protocol. The MESI protocol is named based on the possible states for the data in the cache. In the MESI protocol, there are four states (coherence tracking states) - Modified (M), Exclusive (E), Shared (S), and Invalid (I).

Modified (M) represents that the cache line is present only in the current cache, and has been modified (M state) from the value in main memory. The cache is required to write the data back to main memory, before permitting any other read of the (no longer valid) main memory state. The write-back changes the line to the Shared state(S).

Exclusive (E) represents that the cache line is present only in the current cache, and matches main memory version. The cache line can be changed to the Shared state at any time, in response to a read request. Alternatively, the cache line can be changed to the Modified state when writing to the cache line.

Shared (S) represents that the cache line can be stored in other caches of the machine and matches the main memory version. The line can be discarded (changed to the Invalid state) at any time.

Invalid (I) represents that the cache line is invalid (unused).

As would be understood, the tracking of cache state requires memory and clock cycles. Computer resources are used when changing states and writing data from the cache line to or from other memory locations. While the use of the cache and cache states save computer time and processing, further minimizing changing states of the cache lines when unnecessary and the writing from the cache to or from memory can be beneficial. As such, minimizing the probing of a cache and minimizing the changing of states can provide a benefit when certain conditions exist.

Techniques for storing information about what data is, even without actually storing any data, along with the ‘coherence’ tracking information in storage structures are provided. These techniques include omitting probes, if some other coherence conditions were met. One example of coherence tracking information, by way of non-limiting example, includes information regarding whether a cache line is not in a writable state (e.g., a level 2 cache line).

A method for omission of probes when requesting data stored in memory is provided in this disclosure. The omission of probes method includes creating a coherence directory entry in a coherency directory associated with a cache to track information associated with at least one of cache line, determining whether cache line data for the coherence directory entry is a trackable pattern, and setting an indication in the coherence directory entry associated with the cache line data indicating that one or more reads for the cache line data can be serviced without sending probes. The method can include configurations where trackable pattern comprise zeroes and where the cache line is in a MESI state. The coherence directory entry in the coherency directory can include information indicating whether cache line is present in another cache in a cache hierarchy.

A system for omission of probes when requesting data stored in memory is also provided in this disclosure. The system includes a processor, and a memory. The memory includes a cache hierarchy; and a coherency directory associated with the cache hierarchy, the coherency directory including a plurality of coherency directory entries to track information associated with a cache line, each entry being associated with a cache line, wherein each entry includes an indication indicating that one or more reads for cache line data associated with one of the plurality of coherence directory entries can be serviced without sending probes in response to the cache line data for the entry being a trackable pattern. The system can include configurations where trackable pattern comprise zeroes and where the cache line is in a MESI state. The coherence directory entry can indicate that a line is present in another cache.

A method for providing extra data storage capacity in a memory is provided in this disclosure. The extra data storage capacity method includes actively tracking cache lines in a coherence directory of a cache, invalidating the cache line and informing the coherence directory, determining whether data is a trackable pattern, and if the coherence directory is utilized, and if the determining indicates that the data is a trackable pattern: updating the coherence directory that the cache line is no longer in cache, updating the coherence directory to indicate cache line data is zero, and servicing reads to the cache line from the coherence directory and supplying the specified data. The method can include trackable patterns comprising zeroes.

A system providing extra data storage capacity in a memory is also provided in this disclosure. The system includes a processor and a memory. The memory includes a coherency directory associated with the cache hierarchy, the coherency directory including a plurality of coherency directory entries to track information associated with a cache line, each entry being associated with a cache line, wherein the processor invalidates the cache line, informs the coherence directory of the invalidation, and determines if data in the cache line is a trackable pattern; and when the determining indicates that the data is a trackable pattern, the processor updating the coherence directory that the cache line is no longer in the cache hierarchy, updating the coherence directory to indicate the cache line data is zero, and servicing reads to the cache line from the coherence directory to supply the specified data. The coherence directory entry can indicate that a line is present in another cache.

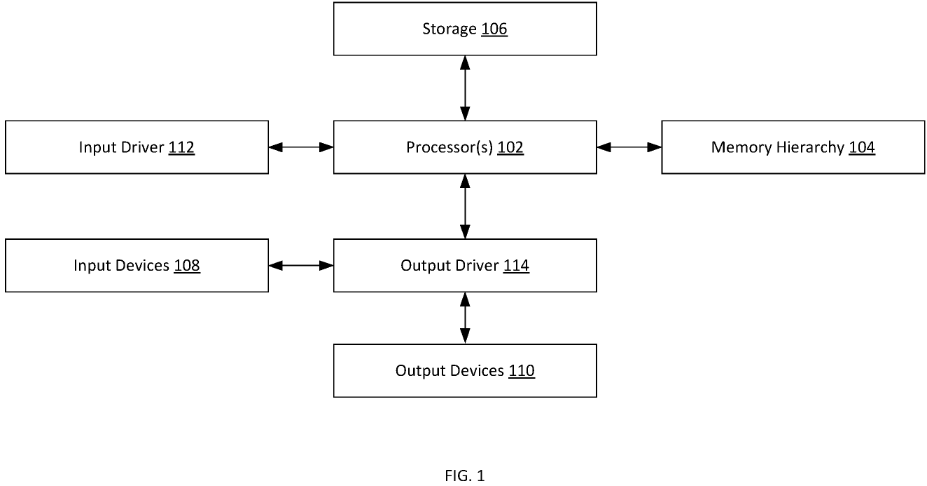

FIG. 1 is a block diagram of an example device 100 in which aspects of the present disclosure are implemented. The device 100 includes, for example, a computer, a gaming device, a handheld device, a set-top box, a television, a mobile phone, or a tablet computer. The device 100 includes one or more processors 102, a memory hierarchy 104, a storage device 106, one or more input devices 108, and one or more output devices 110. The device 100 can also optionally include an input driver 112 and an output driver 114. It is understood that the device 100 can include additional components not shown in FIG. 1.

The one or more processors 102 includes a central processing unit (CPU), a graphics processing unit (GPU), a CPU and GPU located on the same die, or one or more processor cores, wherein each processor core is a CPU or a GPU. In some examples, the one or more processors 102 includes any number of processors. In some examples, the one or more processors 102 includes one or more processor chips. In some examples, each processor chips includes one or more processor cores.

Part or all of the memory hierarchy 104 may be located on the same die as one or more of the one or more processors 102, or can be located partially or completely separately from the one or more processors 102. The memory hierarchy 104 includes, for example, one or more caches, one or more volatile memories, one or more non-volatile memories, and/or other memories, and can include one or more random access memories (“RAM”) of one or a variety of types.

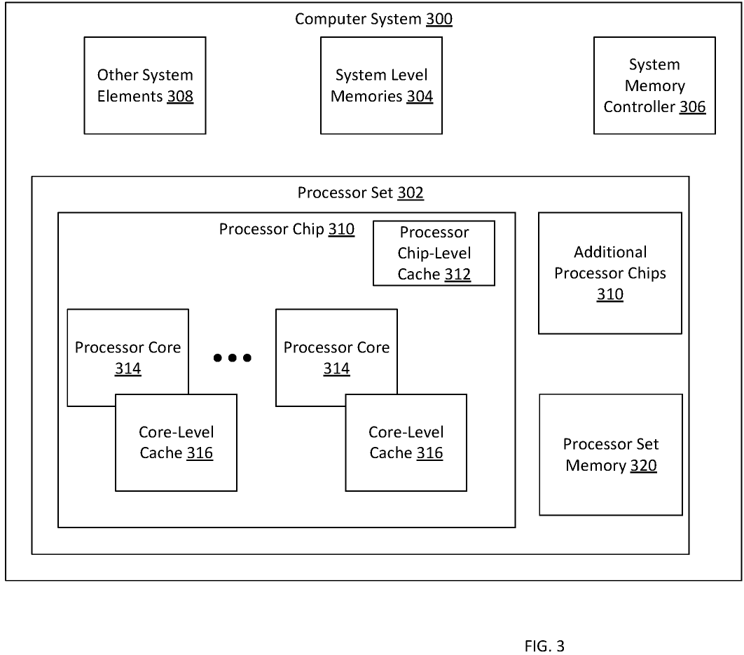

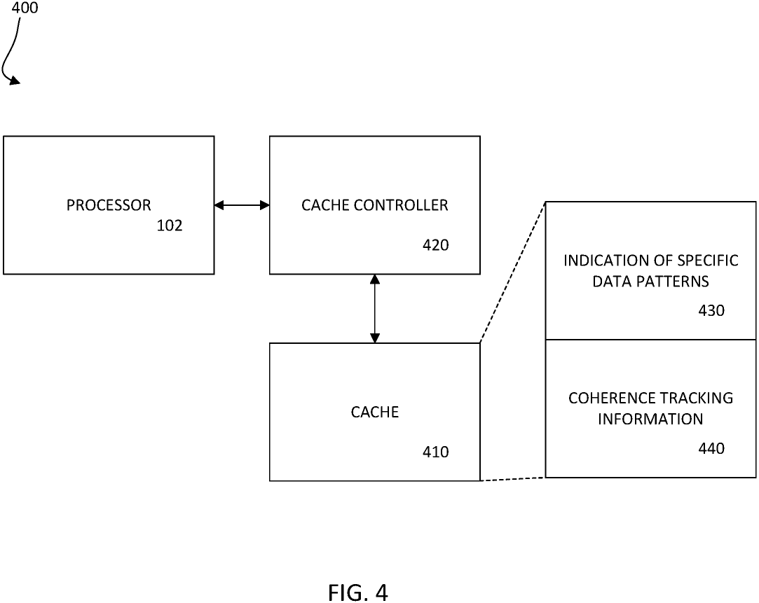

In some examples, the elements of the memory hierarchy 104 are arranged in a hierarchy that includes the elements of the one or more processors 102. Examples of such an arrangement is provided in FIGS. 3 and 4.

The storage device 106 includes a fixed or removable storage, for example, a hard disk drive, a solid-state drive, an optical disk, or a flash drive. The input devices 108 include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. The input driver 112 and the output driver 114 are optional components, and that the device 100 will operate in the same manner if the input driver 112 and the output driver 114 are not present.

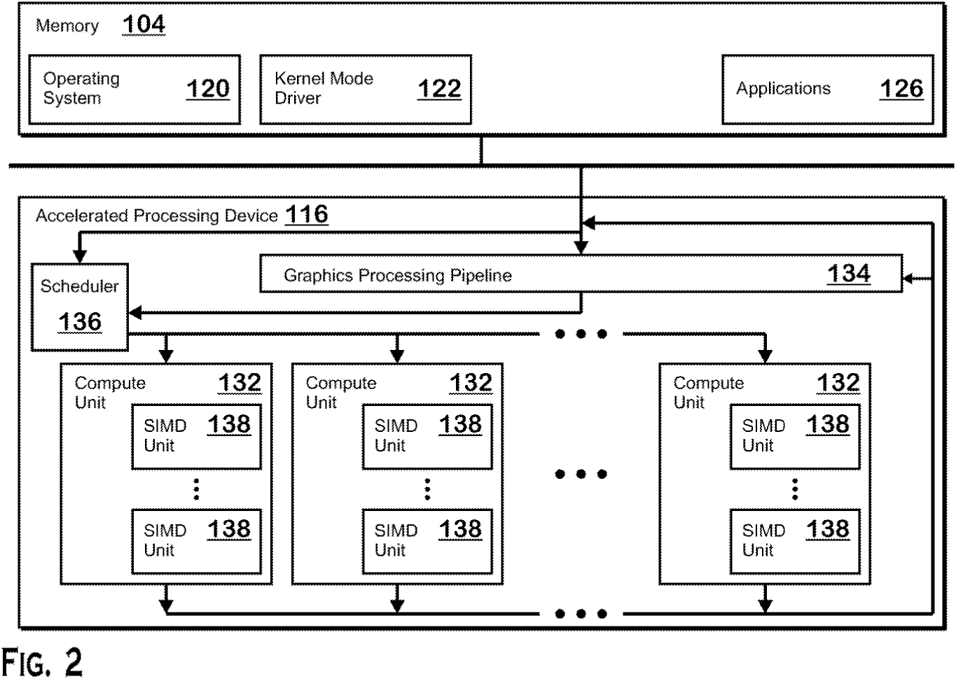

FIG. 2 is a block diagram of an instruction execution pipeline 200, located within the one or more processors 102 of FIG. 1. In various examples, any of the processor cores of the one or more processors 102 of FIG. 1 are implemented as illustrated in FIG. 2.

The instruction execution pipeline 200 retrieves instructions from memory and executes the instructions, outputting data to memory and modifying the state of elements within the instruction execution pipeline 200, such as registers within register file 218.

The instruction execution pipeline 200 includes an instruction fetch unit 204 configured to fetch instructions from system memory (such as memory 104) via an instruction cache 202, a decoder 208 configured to decode fetched instructions, functional units 216 configured to perform calculations to process the instructions, a load store unit 214, configured to load data from or store data to system memory via a data cache 220, and a register file 218, which includes registers that store working data for the instructions. A reorder buffer 210 tracks instructions that are currently in-flight and ensures in-order retirement of instructions despite allowing out-of-order execution while in-flight. “In-flight” instructions refers to instructions that have been received by the reorder buffer 210 but have not yet had results committed to the architectural state of the processor (e.g., results written to a register file, or the like). Reservation stations 212 maintain in-flight instructions and track instruction operands. When all operands are ready for execution of a particular instruction, reservation stations 212 send the instruction to a functional unit 216 or a load/store unit 214 for execution. Completed instructions are marked for retirement in the reorder buffer 210 and are retired when at the head of the reorder buffer queue 210. Retirement refers to the act of committing results of an instruction to the architectural state of the processor. For example, writing an addition result to a register, by an add instruction, writing a loaded value to a register by a load instruction, or causing instruction flow to jump to a new location, by a branch instruction, are all examples of retirement of the instruction.

Various elements of the instruction execution pipeline 200 communicate via a common data bus 222. For example, the functional units 216 and load/store unit 214 write results to the common data bus 222 which can be read by reservation stations 212 for execution of dependent instructions and by the reorder buffer 210 as the final processing result of an in-flight instruction that has finished execution. The load/store unit 214 also reads data from the common data bus 222. For example, the load/store unit 214 reads results from completed instructions from the common data bus 222 and writes the results to memory via the data cache 220 for store instructions.

The instruction execution pipeline 200 executes some instructions speculatively. Speculative execution means that the instruction execution pipeline 200 performs at least some operations for execution of the instruction, but maintains the ability to reverse the effects of such execution in the event that the instruction was executed incorrectly.

In an example, the instruction execution pipeline 200 is capable of performing branch prediction. Branch prediction is an operation in which the instruction fetch unit 204 predicts the control flow path that execution will flow to and fetches instructions from that path. There are many ways to make the prediction, and some involve maintaining global or address-specific branch path histories (e.g., histories of whether branches are taken or not taken and/or the targets of such branches), and performing various operations with such histories. The execution pipeline (e.g., the functional units 216) actually executes branches to determine the correct results of such branches. While instructions from the predicted execution path are executing but before the functional units 216 actually determines the correct execution path, such instructions are considered to be executing speculatively, because it is possible that such instructions should not actually be executed. There are many other reasons why instructions could execute speculatively. While this example deals with speculative execution, the present storing an indication of a specific data pattern in spare directory entries can be utilized with any execution microprocessor. That is, the speculative microprocessor is exemplary only.

It is possible to execute store instructions speculatively. Speculative execution occurs by performing various operations for an instruction but not committing such operations until the instruction becomes non-speculative. In an example, executing a store instruction speculatively includes placing the instruction into a load/store unit 214, determining the data to store, determining an address to store the data to (which can involve address calculation and translation). During this time, the reorder buffer 210 holds the store instruction and does not permit the instruction to retire — commit the results — until the store instruction becomes non-speculatively executing.

Instructions could execute speculatively for a variety of reasons such as executing in a predicted branch control flow path or for a variety of other reasons. Part of the execution of a store instruction involves writing the data to be stored into a cache. To do this, a cache controller gains exclusive access to the appropriate cache line and then writes the specified data into that cache line. Gaining exclusive access to the appropriate cache line involves causing other caches (e.g., all other caches) to invalidate their copies of the cache line. Doing this prevents conflicting versions of data for that cache line from existing in different cache memories. In the MESI (“modified, exclusive, shared, invalid”) protocol, the instruction execution pipeline 200 that executes the store gains exclusive access to the cache line and the other units set their copy of the cache line to be invalid.

The instruction execution pipeline 200 is an out-of-order execution pipeline that attempts to perform various operations for instructions early. One example of such an operation is the invalidation described above. Specifically, for execution of a store instruction, the instruction execution pipeline 200 is permitted to, and often does, request invalidation of other memories’ copies of the cache line early on in the execution of a store instruction, so that when the store instruction is ready to write the associated data, the instruction execution pipeline 200 does not need to wait as long as if the invalidation were to occur at a later time. An issue arises, however, where speculative execution of a store instruction occurs. Specifically, as described above, it is possible for the instruction execution pipeline 200 to request invalidation of cache lines for a speculatively executing store instruction, and to make such request substantially before the store instruction is ready to write data. However, it is possible that the speculative execution of the store instruction is actually incorrect. For example, it is possible that the store instruction was executing on an incorrectly predicted control flow path (such as past the branch not-taken point where the branch is actually taken). In this case, the act of causing the various copies of the cache line involved to be invalidated from the various memories is wasted, and those various memories can need to reacquire those cache lines in shared or exclusive state.

In order to save time, such as by eliminating or minimizing probes, an indication of a specific data pattern can be stored in spare directory entries. The indication of a specific data pattern can be stored in ‘coherence directories.’ A coherence directory is used for directory-based cache coherence which is a type of cache coherence mechanism, where the coherence directories is used to manage the cache in place of other techniques such as snoopy methods. The coherence directory can be a storage location within the cache hierarchy, for example.

In an implementation, a coherence directory includes one or more of the multiple CPU cores with private level 2 caches, which connect to a level 3 cache. The level 3 cache has an exact copy of the level 2 cache addresses, including precise information as to which of the many level 2 caches has the cache line. When servicing a level 2 cache miss from a given core, the level 3 looks up both the level 3 cache tags as well as the copy of the level 2 cache addresses to determine where the cache line lives.

In some other implementations, instead of an exact copy of the addresses being tracked, there is a set-associative structure as the coherence directory. This can be implemented as ‘additional level 3 cache tags’ or by its own dedicated structure. For example, if the level 3 cache is a 12-way set associative cache (with 12 tags and storing 12 data lines per index), you could have an additional 4 tags representing the ‘coherence’ entries. These do not correspond to data stored in the level 3, but instead have a pointer to one or more level 2 caches which house the cache line. The size of this structure is provisioned based on performance analysis, and is often overprovisioned to account for some worst-case scenarios where the cache line addresses in the level 2 caches form a ‘hotspot’ in the level 3 directory, due to its set-associative nature.

Beyond the level 3 caches, ‘system coherence manager’ can be used to track which level 3 caches house a cache line. The system coherence manager is a mixture of both cache line address pointers and larger granularity pointers (for example a 4 kilobyte page).

Regardless of the implementation scheme, the coherence directory provides information to the cache controller indicating that the cache controller may have to send a probe to one or more caches to get the most recent data. These probes can be performance limiting - adding latency to the original cache access, causing bandwidth problems when many probes are active, causing bank conflicts or other perturbation to the level 2 cache while the cache controller handles the probe, etc.

FIG. 3 is a block diagram of a computer system 300, according to an example. In some examples, the computer system 300 is the computer system 100 of FIG. 1. The computer system 300 includes a processor set 302, one or more system-level memories 304, a system memory controller 306, and other system elements 308.

The processor set 302 includes one or more processor chips 310. Each processor chip 310 includes a processor chip-level cache 312 and one or more processor cores 314. Each processor core 314 has an associated core-level cache 316. Each of the processor cores 314 includes one or more execution pipelines such as the instruction execution pipeline 200 of FIG. 2.

The caches and memories illustrated in FIG. 3 operate in parallel and therefore use a coherence protocol to ensure data coherence. One example of such a protocol is the modified-exclusive-shared-invalid (“MESI”) protocol. Each cache line includes an indication of one of these four states. The modified state indicates that the copy of the cache line stored in a particular cache is modified with respect to the copy stored in a backing memory, and thus that the cache line must be written to the backing memory when the cache line is evicted. The exclusive state indicates that the cache line is stored in a particular cache and not in any other cache at the same level of the hierarchy. A cache line that is marked as exclusive can be stored in a higher level of the hierarchy. For example, a cache line stored in a level 0 cache in an exclusive state can also be stored in the level 1 cache directly above the level 0 cache. The shared state indicates that the cache line is stored in multiple caches at the same level of the hierarchy. The invalid state indicates that the cache line is not valid within the particular cache where that cache line is marked invalid (although another cache can store a valid copy of that cache line).

Each processor core 314 has an associated core-level cache 316. When a processor core 314 executes a memory operation such as a load operation or a store operation, the processor core 314 determines whether the cache line that stores the data for the memory operation is located within the core-level cache 316 associated with the processor core 314. If such cache line is not located within the core-level cache 316, then the core-level cache 316 attempts to fetch that cache line into that core-level cache 316 from a higher-level cache such as the processor chip-level cache 312. The processor chip-level cache 312 serves both as a higher-level cache memory and as a controller that manages the coherence protocol for the processor chip-level cache 312 and all core-level caches 316 within the same processor chip 310. Thus, the processor chip-level cache 312 checks itself to determine whether the requested cache line is stored therein for the purpose of providing that cache line to the requesting processor core 314. The processor chip-level cache 312 provides the cache line to the requesting core 314 either from its own contents or once fetched from a memory that is higher up in the hierarchy.

The processor chip-level cache 312 manages the coherence protocol for the core-level caches 316. In general, the processor chip-level cache 312 manages the protocol states of the cache lines within the core-level caches 316 so that if any cache line is in an exclusive state in a particular core-level cache 316, no other core-level cache 316 has that cache line in any state except invalid. Multiple core-level caches 316 are permitted to have the cache line in a shared state.

The protocol works on a level-by-level basis. More specifically, at each level of the memory hierarchy, each element within that levels is permitted to have a cache line in any of the states of the protocol. In an example, at the level of the processor set 302, each chip 310 (thus, each processor chip-level cache 312) is permitted to have a cache line in one of the states, such as a shared state or an exclusive state. A controller for a particular level of the hierarchy manages the protocol at that level. Thus, the processor set memory 320 manages the states of the processor chip-level caches 312. The processor chip-level cache 312 for any particular processor chip 310 manages the states of the core-level caches 316, and a system memory controller 306 manages the states for the processor set 302 and other system elements 308 that store a particular cache line.

When a processor core 314 executes a store instruction, the processor core 314 requests that the cache line that includes the data to be written to is placed into the associated core-level cache 316 in an exclusive state. Part of satisfying this request involves requesting that the all other caches (other than the caches “directly above” the core-level cache 316) invalidate their copy of that cache line. As stated elsewhere, the processor core 314 issues an exclusive read, and the other caches invalidate the copies in response to that exclusive read.

In some implementations, the information about the data is stored, even without actually storing the data, along with the ‘coherence’ tracking information in these structures. By storing information about the data, a probe may be omitted, if other coherence conditions are met. By way of non-limiting example, a coherence condition includes where the level 2 cache line is not in a writable state. In an implementation, a 1 bit per coherence entry is stored. For example, the data can be stored in a different cache, such as the level 3 cache for example, indicating the cache line is all zeroes. Instead of probing the cache that is known to be zeroes, the cache controller satisfies the request by returning all zeroes, without looking up any data storage. More generally, instead of 1 bit representing ‘zero’, there can be multiple encodings stored for common data patterns. These multiple encodings can be a fixed set of data patterns, or an index into a ‘dictionary of patterns’ that were determined at runtime to be common. As dictionaries of patterns are understood in the art and in the area of cache compression, more detail is not presented regarding dictionaries.

In addition to eliminating probes, implementations can also create the illusion of additional cache capacity. In at least one implementation, there are extra ‘tags’ in a level 3 cache that do not have any data, since they are just there for tracking addresses. Upon insertion of a line into the level 3 cache, if the data value is zero, one of the unused ‘coherence directory’ tags is available for use instead of one of the tags which has corresponding data storage.

In some implementations, the indication of specific data patterns is stored in the same directory as coherence tracking information. As would be understood such a storing location may be determined for ease of access and storing in the same directory as the coherence tracking information and is only one implementation. Other locations for storing would be understood by those possessing an ordinary skill in the art.

FIG. 4 illustrates a computer system 400 utilizing a single level cache system operating with the stored indication of a specific data pattern in a spare directory. As illustrated, computer system 400 includes a processor 102 and a cache 410 and a cache controller 420 (e.g., the processor chip-level cache 312, the processor set memory 320, or the system memory controller 306) coupled to the cache 410. System 400 includes an indication of specific data patterns 430. Indication 430 is coupled to one or both of cache 410 and controller 420 and can be stored within cache 410. As set forth above, in an implementation, coherence tracking information 440 is stored with the indication 430.

While not specifically illustrated, system 400 may include one or more levels of cache hierarchy. For example, one or more lowest levels of the hierarchy (first-order processor-memory hierarchy level), one or more next-level-up second-order processor-memory hierarchy levels, arranged in a hierarchy, one or more third-order processor-memory hierarchy levels, and, optionally, additional hierarchy levels, not shown. While system 400 illustrates only a single level of a cache hierarchy, additional levels may be utilized. As would be understood, using a multi-level hierarchy creates the opportunity to store indication 430 and coherence tracking information 440 associate with cache 410 in a second cache (not shown) that may be present at another level in the hierarchy.

FIG. 4 is a block diagram of a computer system 400 capable of executing a store and read using an indication of a specific data pattern. FIG. 4 illustrates elements from FIG. 3 necessary to understand the described capabilities. As would be understood, the system 300 of FIG. 3 is an example of the system 400 of FIG. 4. Thus, while FIG. 3 shows specific types of hierarchy level elements such as cores, chips, and the like, the system of FIG. 4 does not necessarily include similar elements or groupings of elements and instead provides a simplified diagram to aid in the understanding of the described capabilities. For example, the core-level caches 316 are examples of the cache 410 and the processor 102 can be the processor core 314. As would be understood cache 410 and processor 102 may represent processors and caches at other levels of the hierarchy of FIG. 3 including system level memories 304 and system memory controller 306 as well as processor set memory 320, for example.

In some implementations, the indication of specific data patterns 430 is stored, even without actually storing the data, along with coherence tracking information 440 in the cache hierarchy, such as in cache 410, for example. By storing the indication 430 and utilizing the indication 430, a probe can be omitted, if other coherence conditions exist. One coherence condition, by way of non-limiting example, includes an implementation where the level 2 cache line is not in a writable state.

In an implementation, a 1 bit per coherence entry is stored as indication 430 representing the cache line is all zeroes. Instead of probing the cache that is known to be zeroes as identified by indication 430, the cache controller 420 satisfies the request by returning all zeroes, without looking up any data storage. By saving the lookup or probe, system resources are saved.

More generally, instead of the exemplary 1 bit representing ‘zero’, there can be multiple encodings stored for common data patterns. A plurality of indications 430 are used to represent these common data patterns. These multiple encodings can be a fixed set of data patterns, or an index into a ‘dictionary’ of patterns that were determined at runtime to be common. Multiple bits can be used to represent other common data patterns beyond the described all zero condition. As dictionaries of patterns are understood in the art and in the area of cache compression, more detail is not presented regarding dictionaries.

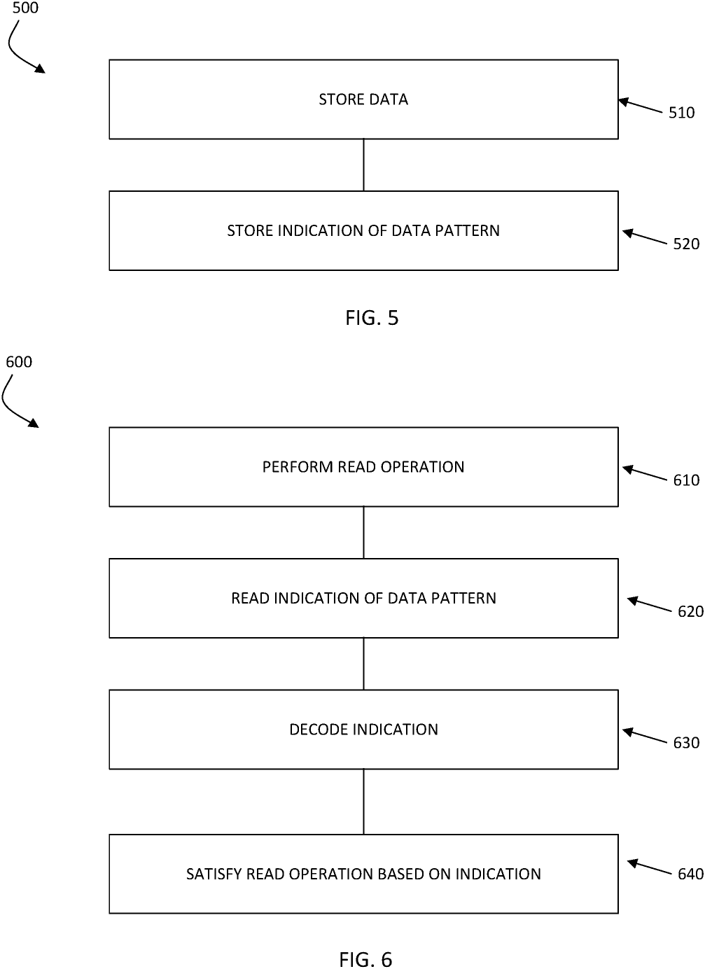

FIG. 5 is a flow diagram of a method 500 for storing an indication of a specific data pattern in a spare directory, according to an example. Although described with respect to the systems of FIGS. 1-4, those of skill in the art will understand that any system, configured to perform the steps of the method 500 in any technically feasible order, falls within the scope of the present disclosure.

At step 510, method 500 includes a processing element issuing a store request to store data within the cache hierarchy. At step 520, an indication of a specific data pattern is stored. The indication of the specific data pattern is associated with the data that the processing element issued a store request to store. In an implementation, the indication is stored within the cache hierarchy and in other implementations the indication is stored in a different level of the hierarchy from the location the data is stored. By storing the indication, a probe may be omitted, if some other coherence conditions exist. One coherence condition, by way of non-limiting example, includes an implementation where the level 2 cache line is not in a writable state. In an implementation, a 1 bit per coherence entry is stored indicating the cache line is all zeroes. Instead of probing the cache that is known to be zeroes, the cache controller satisfies the request by returning all zeroes, without looking up any data storage. More generally, instead of 1 bit representing ‘zero’, there can be multiple encodings stored for common data patterns. These multiple encodings may be a fixed set of data patterns, or an index into a ‘dictionary’ of patterns that were determined at runtime to be common. As dictionaries of patterns are understood in the art and in the area of cache compression, more detail is not presented regarding dictionaries.

FIG. 6 is a flow diagram of a method 600 for storing an indication of a specific data pattern in a spare directory, according to an example. Although described with respect to the systems of FIGS. 1-4, those of skill in the art will understand that any system, configured to perform the steps of the method 600 in any technically feasible order, falls within the scope of the present disclosure.

At step 610, method 600 includes a processing element issuing a read request to perform a read operation to read data from the data hierarchy. Since the data requested to be read is identified as a specific data pattern, the associated indication of a specific data pattern is read from the data hierarchy at step 620. The indication is decoded at step 630. At step 640, the read operation is satisfied based in the decoded indication. By reading the indication, a probe may be omitted, if some other coherence conditions exist. One coherence condition, by way of non-limiting example, includes an implementation where the level 2 cache line is not in a writable state. In an implementation, a 1 bit per coherence entry is stored indicating the cache line is all zeroes. Instead of probing the cache that is known to be zeroes, the cache controller satisfies the request by returning all zeroes, without looking up any data storage. More generally, instead of 1 bit representing ‘zero’, there can be multiple encodings stored for common data patterns. These multiple encodings may be a fixed set of data patterns, or an index into a ‘dictionary’ of patterns that were determined at runtime to be common. As dictionaries of patterns are understood in the art and in the area of cache compression, more detail is not presented regarding dictionaries.

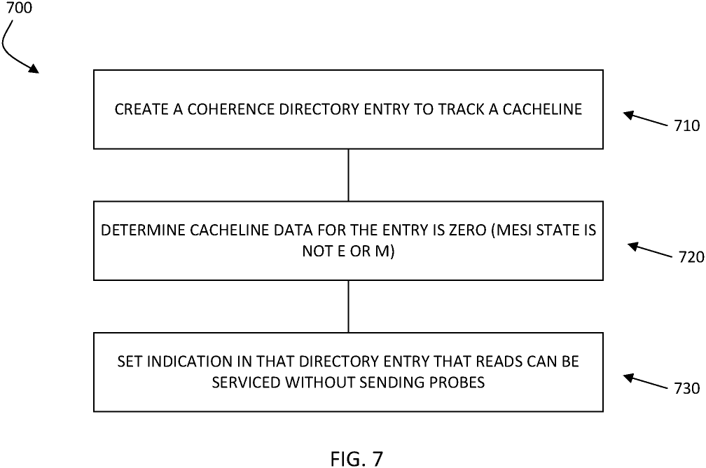

FIG. 7 illustrates a method 700 for the omission of probes in the systems of FIGS. 1-4. In other words, probes for data stored in the hierarchy to determine where the data is located in the hierarchy and the status of the data within the hierarchy may be unnecessary and therefore avoided or omitted. Method 700 stores an indication in a coherence directory entry which indicates that a cache line is present in one or more other caches. In an implementation, the indication is stored with the cache hierarchy, and in other implementations, the indication is stored in a different level of the cache hierarchy from that which the data associated therewith is stored. By way of example, a cache line is in a valid non-exclusive MESI state. The data in the cache line is a trackable pattern, such as zero, for example. Responsive to a request to read the data from the cache line, the trackable pattern can be recognized, and probes are not sent to the other caches(s). The system returns the specified data (in the example zeros) is returned based on the indication. This method 700 represents the omission of probes.

Method 700 includes creating a coherence directory entry to track a cache line at step 710. By way of specific example, the coherence directory entry is created in a level 3 cache directory to track a cache line for a level 2 cache.

At step 720, method 700 includes determining the cache line data for the entry is zero (or some other trackable pattern) when the MESI state is not exclusive (E) or modified (M). Continuing the specific example from above, if the cache line data for the entry is determined to be zero (or other set value) in the level 2 cache and the MESI state is not E or M, the indication is set in that directory entry that reads in the stored state (as certain reads require invalidation) can be serviced without sending probes to the level 2 cache(s). As would be understood, when the cache line data for the entry is in the MESI E or M state, the CPU that holds the cache line data can change the data of the cache line without informing the coherence directory, thus rendering the coherence directory’s knowledge of the cache line’s value incorrect.

At step 730, method 700 includes setting the indication in that directory entry that reads can be serviced without sending probes. Again, referring to the specific example, an indication is set in the coherence directory entry in the level 3 cache that tracks the cache line for the level 2 cache. The indication is configured to indicate that reads to the cache line for the level 2 cache can be serviced with sending probes for the cache line.

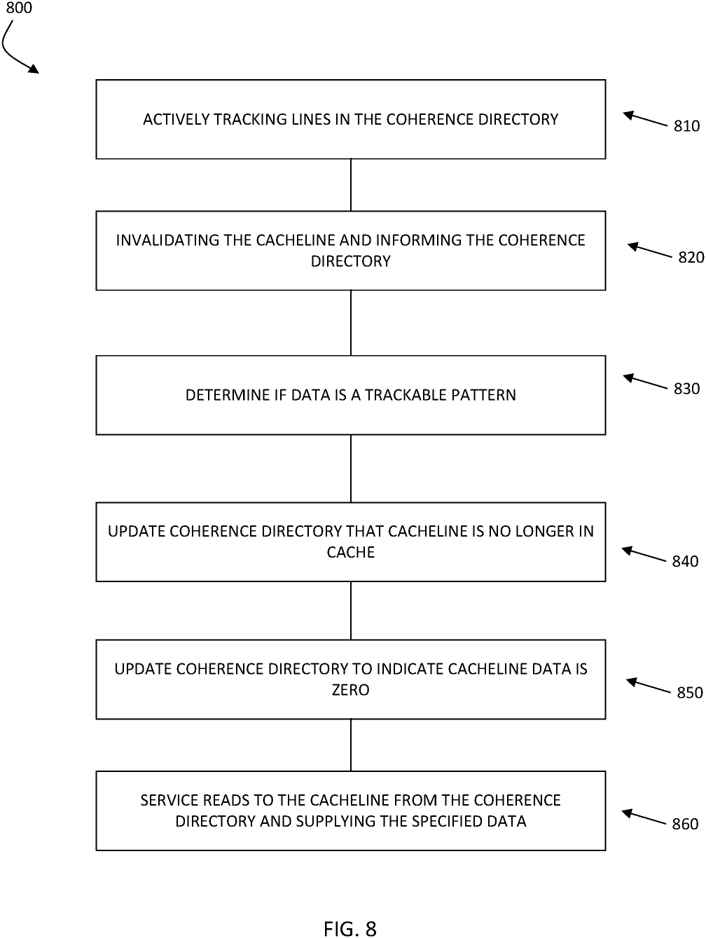

FIG. 8 illustrates a method 800 for extra data storage capacity in the systems of FIGS. 1-4. Method 800 stores an indication in a coherence directory entry which indicates that a line is not present in another cache covered by the directory. This indication can also or alternatively indicate that the entry is available to service reads with the specified data. This method 800 represents the extra data capacity.

Method 800 includes actively tracking lines in the coherence directory at step 810. By way of specific example, a coherence directory in the level 3 cache directory actively tracks lines in the level cache.

At step 820, method 800 includes invalidating the cache line and informing the coherence directory. In the specific example, the level 2 cache line becomes invalid, for example due to a capacity eviction, and informs the coherence directory in the level 3 cache. In other situations, the cache line eviction from the level 2 cache would either place the cache line into the level 3 cache and invalidate the coherence directory entry, and/or evict to memory and invalidate the coherence directory entry.

At step 830, method 800 includes determining if data is a trackable pattern, such as all zeroes, for example. As patterns and tracking patterns are understood in the art and in the area of cache compression, more detail is not presented regarding patterns and pattern tracking.

If the coherence directory is utilized, and if the determining in step 830 indicates that the data is a trackable pattern, method 800 includes updating the coherence directory that the cache line is no longer in cache at step 840, updating the coherence directory to indicate cache line data is zero at step 850, and servicing reads to the cache line from the coherence directory and supplying the specified data at step 860. Again, referring to the specific example, the coherence directory is updated to indicate the cache line is no longer in the level 2 cache. The coherence directory is updated to indicate the cache line data is zero. Subsequent reads to the cache line are serviced from the coherence directory, supplying the specified data without using storage in the level 3 cache.

It should be understood that many variations are possible based on the disclosure herein. Although features and elements are described above in particular combinations, each feature or element can be used alone without the other features and elements or in various combinations with or without other features and elements.

The various elements illustrated in the figures are implementable as hardware (e.g., circuitry), software executing on a processor, or a combination of hardware and software. In various examples, each block, the processor chips 310, the system elements 308, system level memories 304, system memory controller 306, and the illustrated units of the instruction execution pipeline 200 and the computer system 100, are implementable as hardware, software, or a combination thereof. The methods provided can be implemented in a general-purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the implementations.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A method for omission of probes when requesting data stored in memory, said method comprising:
creating a coherence directory entry in a coherency directory associated with a cache to track information associated with at least one of cache line;
determining whether cache line data for the coherence directory entry is a trackable pattern; and
setting an indication in the coherence directory entry associated with the cache line data
indicating that one or more reads for the cache line data can be serviced without sending probes.

2. The method of claim 1 wherein the trackable pattern comprises zeroes.

3. The method of claim 1 wherein the cache line is in a MESI state.

4. The method of claim 3 wherein the MESI state is not in the exclusive (E) or modified (M) state.

5. The method of claim 1 wherein the coherence directory is located in a level 3 cache directory.

6. The method of claim 1 wherein the coherence directory tracks a cache line for a level 2 cache.

7. The method of claim 1 wherein the omitted probes are directed to the level 2 cache.

8. The method of claim 1 wherein each coherence directory entry in the coherency directory includes information indicating whether cache line is present in another cache in a cache hierarchy.

9. A system comprising:
a processor; and
a memory, wherein the memory comprises:
a cache hierarchy; and
a coherency directory associated with the cache hierarchy, the coherency directory including a plurality of coherency directory entries to track information associated with a cache line, each entry being associated with a cache line, wherein each entry includes an indication indicating that one or more reads for cache line data associated with one of the plurality of coherence directory entries can be serviced without sending probes in response to the cache line data for the entry being a trackable pattern.

10. The system of claim 9 wherein the coherence directory is located in a level 3 cache directory.

11. The system of claim 9 wherein the coherence directory tracks a cache line for a level 2 cache.

12. The system of claim 9 wherein the coherence directory entry indicates that a line is present in another cache.

13. A method for providing extra data storage capacity in a coherence directory associated with a cache, said method comprising:
actively tracking cache lines in the coherence directory of the cache;
invalidating the cache line and informing the coherence directory;
determining whether data is a trackable pattern; and
when the coherence directory is utilized, and when the determining indicates that the data is a trackable pattern:
updating the coherence directory that the cache line is no longer in cache,
updating the coherence directory to indicate cache line data is zero, and
servicing reads to the cache line from the coherence directory and supplying the specified data.

14. The method of claim 13 wherein the trackable pattern is all zeroes.

15. The method of claim 13 wherein the coherence directory is located in a level 3 cache directory.

16. The method of claim 13 wherein the coherence directory tracks a cache line for a level 2 cache.

17. A system comprising:
a processor; and
a memory, wherein the memory comprises:
a cache hierarchy; and
a coherency directory associated with the cache hierarchy, the coherency directory including a plurality of coherency directory entries to track information associated with a cache line, each entry being associated with a cache line,
wherein the processor invalidates the cache line, informs the coherence directory of the invalidation, and determines if data in the cache line is a trackable pattern; and
when the determining indicates that the data is a trackable pattern, the processor updating the coherence directory that the cache line is no longer in the cache hierarchy, updating the coherence directory to indicate the cache line data is zero, and servicing reads to the cache line from the coherence directory to supply the specified data.

18. The system of claim 17 wherein the trackable pattern is all zeroes.

19. The system of claim 17 wherein the coherence directory is located in a level 3 cache directory.

20. The system of claim 17 wherein the coherence directory tracks a cache line for a level 2 cache.
